(19) United States
(12) Patent Application Publication
(10) Pub. No.: US 2016/0031133 A1
(43) Pub. Date: Feb. 4, 2016

(54) FOAM MOLDING SYSTEM AND METHOD OF OPERATION

(71) Applicants: John R. Osterday, Arcanum, OH (US); Steven L. Snead, Miamisburg, OH (US)

(72) Inventors: John R. Osterday, Arcanum, OH (US); Steven L. Snead, Miamisburg, OH (US)

(21) Appl. No.: 14/811,194

(22) Filed: Jul. 28, 2015

Related U.S. Application Data
(60) Provisional application No. 62/031,179, filed on Jul. 31, 2014.
(60) Provisional application No. 62/186,072, filed on Jun. 29, 2015.

(51) Int. Cl. B29C 44/60; B29C 44/36

(52) U.S. Cl. CPC B29C 44/60; B29C 44/36; B29K 2105/04

(57) ABSTRACT

A foam molding system and method of operation are provided. The foam molding system includes a molding assembly configured to mix a plurality of constituent materials to form a molding material. A dispenser is operably coupled to receive the molding material. A carrier is positioned to receive the molding material from the dispenser, the carrier being removably coupled to the foam molding machine. An RFID module is coupled to the carrier. An RFID reader is arranged to receive a signal from the RFID module when the carrier is arranged in the foam molding machine. A controller is operably coupled to the RFID reader and the molding assembly, wherein the controller includes a processor that is responsive to executable computer instructions for changing molding parameters in response to the RFID reader receiving the signal from the RFID module.

### CROSS REFERENCE TO RELATED APPLICATIONS

This application claims the benefit of U.S. Provisional Patent Application Ser. No. 62/031,179 filed Jul. 31, 2014, the contents of which are incorporated herein by reference thereto.

This application also claims the benefit of U.S. Provisional Patent Application Ser. No. 62/186,072 filed Jun. 29, 2015, the contents of which are also incorporated herein by reference thereto.

### BACKGROUND OF THE INVENTION

The subject matter disclosed herein relates to a foam molding system and in particular to a foam molding system that may be automatically configured.

Foam molding systems, are often used to fabricate components, such as vehicle seats or other vehicle interior components for example. The foam molding systems may operate with a variety of materials, such as polyurethane for example. These systems are typically general purpose, meaning that they may be used to fabricate many different components. It should be appreciated that each component may have a different chemical makeup for the foam material depending on the structural and performance requirements of the component. To change the settings, the operator uses a control interface that determines various system parameters, such as the time of operation (e.g. the shot time), the flow rate of the material into the mold, and the ratios of the foam base materials for example.

It should be appreciated that proper selection of the parameter settings is desired to provide the intended component performance and properly fill the mold. It should be appreciated that under-filling or over-filling the mold may result in costly scrap and lost production time. Further, having the operator manually set parameter settings takes time and further increases costs.

Accordingly, while existing foam molding systems are suitable for their intended purposes the need for improvement remains, particularly in providing a foam molding system that is automatically configured for operation.

### BRIEF DESCRIPTION OF THE INVENTION

According to one aspect of the invention, a foam molding machine is provided. The foam molding machine includes a molding assembly configured to mix a plurality of constituent materials to form a molding material. A dispenser is operably coupled to receive the molding material. A carrier is positioned to receive the molding material from the dispenser, the carrier being removably coupled to the foam molding machine. An RFID module is coupled to the carrier. An RFID reader is arranged to receive a signal from the RFID module when the carrier is arranged in the foam molding machine. A controller is operably coupled to the RFID reader and the molding assembly, wherein the controller includes a processor that is responsive to executable computer instructions for changing molding parameters in response to the RFID reader receiving the signal from the RFID module.

According to another aspect of the invention, a method of forming an object is provided. A carrier is placed in a foam molding machine, the carrier including an RFID module, the carrier further having a first portion movably coupled to a second portion. The RFID module is activated with an operating field transmitted by an RFID reader operably coupled to the foam molding machine. A signal is transmitted from the RFID module to the RFID reader. Molding parameters in the foam molding machine are changed in response to receiving the signal. A foam material is dispensed into the carrier. The first portion and second portion are closed to define the object. The foam material is expanded within the carrier. The object is removed from the carrier.

According to yet another aspect of the invention, a foam molding machine is provided. The foam molding machine including a molding assembly configured to mix a plurality of constituent materials to form a molding material. A boom is coupled to the molding assembly and movable between at least a first position and a second position. A dispenser is coupled to an end of the boom opposite the molding assembly, the dispenser configured to receive the molding material. A carrier is positioned to receive the molding material from the dispenser, the carrier being removably coupled to the foam molding machine. An RFID module is coupled to the carrier. An RFID reader is arranged to receive a signal from the RFID module when the carrier is arranged in the foam molding machine. A controller is operably coupled to the RFID reader and the molding assembly, wherein the controller includes a processor that is responsive to executable computer instructions for changing molding parameters in response to the RFID reader receiving the signal from the RFID module.

These and other advantages and features will become more apparent from the following description taken in conjunction with the drawings.

### BRIEF DESCRIPTION OF THE DRAWING

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 is a side view illustrating a foam molding machine in accordance with an embodiment of the invention;

FIG. 2 is a schematic illustration of an RFID tag and RFID reader for use with the foam molding machine of FIG. 1 in accordance with an embodiment of the invention;

FIG. 3 is a schematic illustration of a controller for the foam molding machine of FIG. 1 in accordance with an embodiment of the invention;

FIG. 4 is an illustration of a graphical user interface for use with the foam molding machine of FIG. 1 displaying the RFID read tag information in accordance with an embodiment of the invention;

FIG. 5 is an illustration of a graphical user interface for use with the foam molding machine of FIG. 1 displaying an information for writing data to the RFID tad in accordance with an embodiment of the invention; and

FIG. 6 is a flow chart illustrating the operation of the foam molding machine of FIG. 1 in accordance with an embodiment of the invention.

The detailed description explains embodiments of the invention, together with advantages and features, by way of example with reference to the drawings.

### DETAILED DESCRIPTION OF THE INVENTION

Embodiments of the present invention provide advantages in allowing for the automatic configuration of a foam molding machine to fabricate a desired object. Embodiments of the invention provide advantages in allowing for the automatic configuration of a foam molding machine to inject the desired material in the desired volumes. Embodiments of the invention provide advantages in allowing a single foam molding machine to quickly and easily be automatically configured to fabricate different objects.

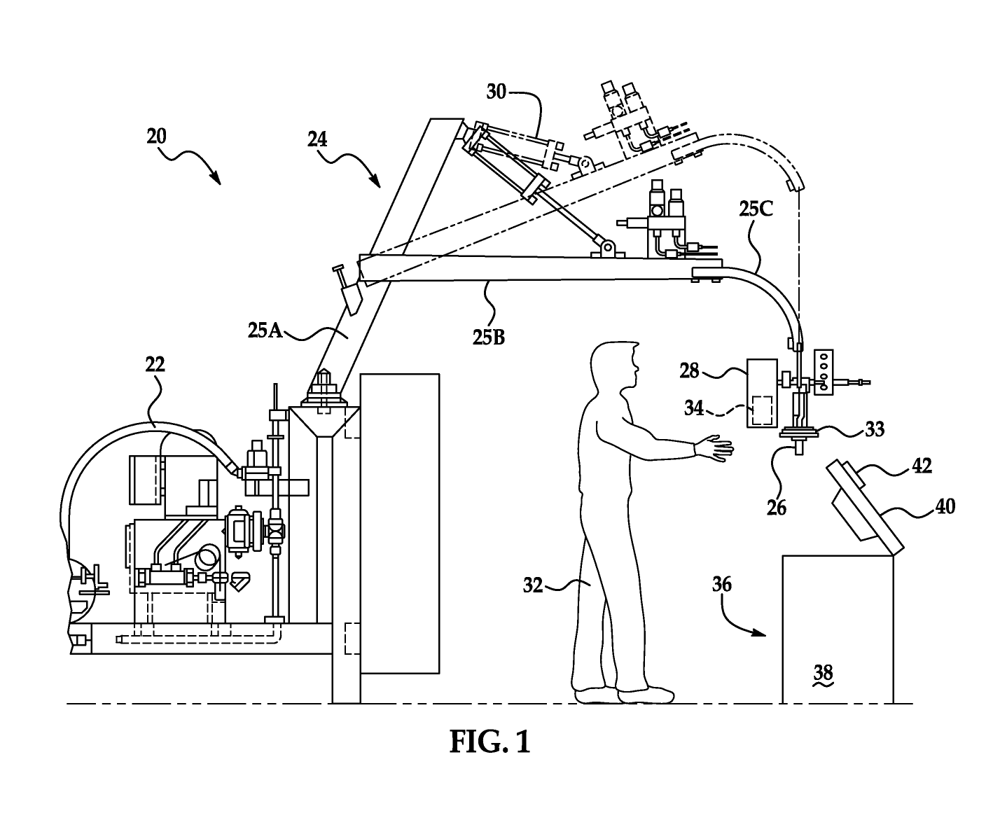

Referring now to FIG. 1, an exemplary foam molding machine 20 is illustrated that may be used to fabricate objects having a portion comprised of a foam material, such as polyurethane foam for example. It should be appreciated that while embodiments herein describe the object as being fabricated with a foam material, this is for exemplary purposes and the claimed invention should not be so limited. The object may also include other components, such as a vinyl skin and plastic or metal retainer components for example. The foam molding machine 20 includes a mixing assembly 22, boom assembly 24, a dispenser 26 and a user interface 28.

The mixing assembly 22 is an assembly that stores, mixes and transfers the foam material with the desired constituent material ratios as is known in the art. The mixing assembly 22 may include material storage modules for holding the constituent materials, mixing modules for combining the constituent materials together, along with valves and pumps to control the flow of the pre-mixed and mixed materials. Attached to the mixing assembly 22 is a boom 24. In one embodiment, the boom 24 is comprised of a plurality of articulated arm segments 25A, 25B that allow the end 25C of the boom 24 to be moved between a first position (raised) and a second position (lowered). An actuator, such as a hydraulic cylinder 30 may be coupled between the arm segments 25A, 25B to assist the operator 32 with movement of the boom 24.

A dispenser 26 is coupled to the end of the boom 24. The dispenser 26 includes operator controls, such as hand grips having actuators. The dispenser 26 may further include control devices, such as valves and nozzles for example, that are operably coupled to the operator controls to control the flow of the foam material from the dispenser 26. In one embodiment, a user interface 28 is coupled to the dispenser 26 to allow the operator 32 to view data associated with the operation of the foam molding machine 20, such as the material, material ratios, material volume flow rate and dispensing time for example. As will be discussed in more detail herein, the user interface 28 may also display information obtained by a RFID tag.

The user interface 28 may include a controller 34 that is responsive to executable computer code for controlling the operation of the user interface 28. In one embodiment the controller 34 also controls the operation of the foam molding machine 20. In one embodiment, the controller 34 is located remotely from the user interface 28, such as in the mixing assembly 22 for example. As will be discussed in more detail below, a radio frequency reading device, such as an RFID reader 33 for example that is compliant with one or more of the International Organization for Standarization (ISO), the International Electrotechnical Commission (IEC), American Standards of Testing and Materials (ASTM) or DASH? Alliance standards for example. In the exemplary embodiment, the RFID reader 33 is configured to receive data from tags at a distance from 10 centimeters up to 12 meters. It should be appreciated that while embodiments herein refer to RFID as the type of communication arrangement, the claimed invention should not be so limited. In other embodiments the communications may be a near field or NFC arrangement. The term “near field communications” refers to a communications system that allows for a wireless communications between two devices over a short or close range, typically less than 5 inches (127 millimeters).

A carrier 36 is positioned adjacent the dispenser 26. The carrier 36 is a container that typically includes a first portion 38 and a second portion 40. The portions 38, 40 define cavities that cooperate to mold the shape of the object being fabricated. For example, in the case of a vehicle glove box, a vinyl skin is placed in the first portion 38 and a retainer member (typically a plastic/metal structure) is placed in the second portion 40. Foam material is dispensed into the area between the skin and the retainer. The carrier 36 is closed until the foam material has finished expanding and is starting to cure (setup). The carrier 36 is then opened, the fabricated object removed and the process is repeated until the desired number of objects are formed.

When the operator desires to fabricate a different object, the carrier is replaced with one suitable (e.g. a different shape) for the new object. It should be appreciated that different objects that are formed by the foam molding machine will have different functional specifications. As a result, the even if different objects use the same base material (i.e. polyurethane foam), the ratio of the constituent materials used to make the foam may be different. By changing the ratios of the constituent materials, the density of the foam may be changed, resulting in the object having a softer or a harder feel.

Traditionally, these material ratios were manually input by the operator into the foam molding machine. In the exemplary embodiment, the carrier 36 includes a RF device, such as an RFID module 42, coupled to the second portion 40. The RFID module 42 may be compliant with one or more of the International Organization for Standarization (ISO), the International Electrotechnical Commission (IEC), American Standards of Testing and Materials (ASTM) or DASH? Alliance standards for example. The RFID module 42 cooperates with the RFID reader 33 to transfer data from the RFID module 42 to the controller 34.

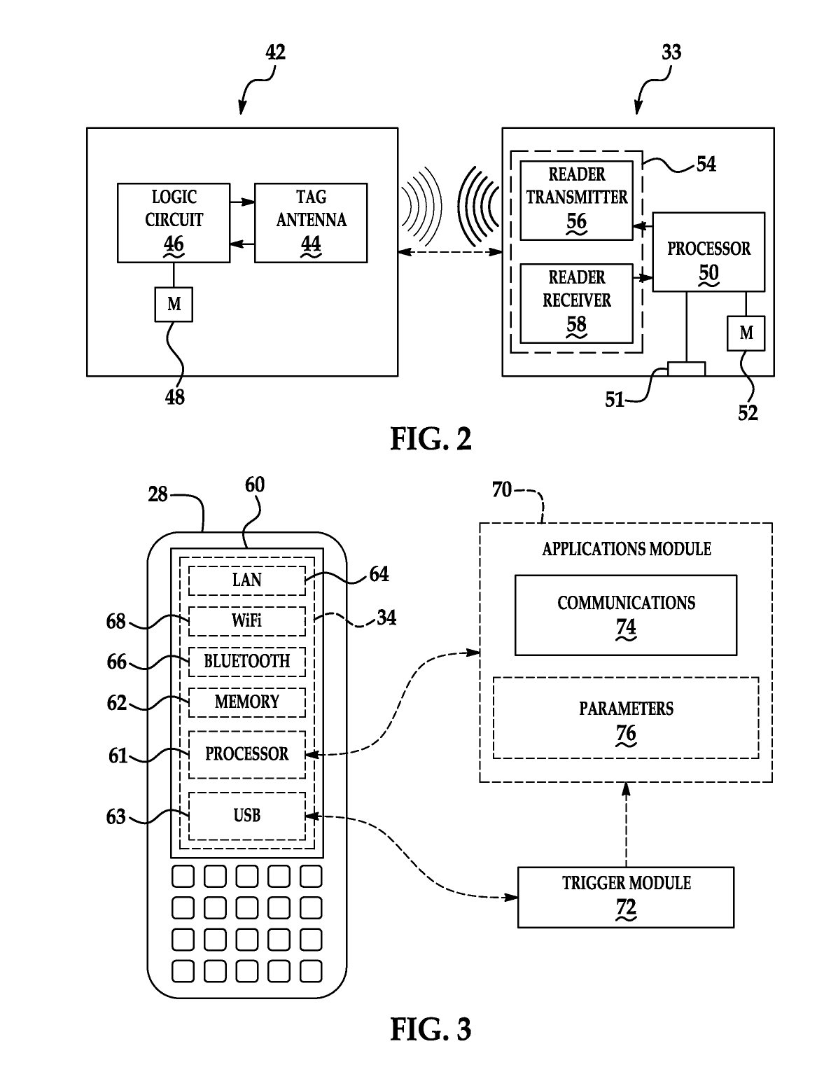

Referring now to FIG. 2, an exemplary RFID module 42 (sometimes referred to as a tag or listening device) and RFID reader 33 (sometimes referred to as a polling device). The use of RFID further provides advantages in that communications may be established and data exchanged between the RFID module 42 and the reader 33 without the NFC module 42 having a power source such as a battery. To provide the electrical power for operation of the NFC module 42, the reader 33 emits a radio frequency (RF) field (the Operating Field). Once the RFID module 42 is moved within the Operating Field, the RFID module 42 and reader 33 are inductively coupled, causing current flow through a module antenna 44. The generation of electrical current via inductive coupling provides the electrical power to operate the RFID module 42 and establish communication between the module and reader, such as through load modulation of the Operating Field by the RFID module 42. The modulation may be direct modulation, frequency-shift keying (FSK) modulation or phase modulation, for example. In one embodiment, the transmission frequency of the communication is 13.56 megahertz with a data rate of 106-424 kilobits per second.

In one embodiment, the RFID module 42 includes a logic circuit 46 that may include one or more logical circuits for executing one or more functions or steps in response to a signal from the antenna 44. It should be appreciated that logic circuit 46 may be any type of circuit (digital or analog) that is capable of performing one or more steps or functions in response to the signal from antenna 44. In one embodiment, the logic circuit 46 may further be coupled to one or more memory devices 48 configured to store information, such as molding parameter values for example. The information stored in memory device 48 may be accessed by logic circuit 46. RFID modules may be configured to read and write many times from memory 48 (read/write mode) or may be configured to write only once and read many times from memory 48 (card emulation mode). For example, where only static instrument configuration data is stored in memory 48, the RFID module may be configured in card emulation mode to transmit the configuration data in response to a reader device 33 being brought within range of the antenna 44.

In addition to the circuits/components discussed above, in one embodiment the RFID module 42 may also include a power rectifier/regulator circuit, a clock extractor circuit, and a modulator circuit. The Operating Field induces a small alternating current (AC) in the antenna when the reader is brought within range of the tag. The power rectifier and regulator converts the AC to stable DC and uses it to power the RFID module, which immediately “wakes up” or initiates operation. The clock extractor separates the clock pulses from the Operating Field and uses the pulses to synchronize the logic, memory, and modulator sections of the NFC module with the RFID reader. The logic circuit separates the 1's and 0's from the Operating Field and compares the data stream with its internal logic to determine what response, if any, is required. If the logic circuit determines that the data stream is valid, it accesses the memory section for stored data. The logic circuit encodes the data using the clock extractor pulses. The encoded data stream is input into the modulator section. The modulator mixes the data stream with the Operating Field by electronically adjusting the reflectivity of the antenna at the data stream rate. Electronically adjusting the antenna characteristics to reflect RF is referred to as backscatter. Backscatter is a commonly used modulation scheme for modulating data on to RF carrier. In this method of modulation, the tag coil (load) is shunted depending on the bit sequence received. This in turn modulates the RF carrier amplitude. The reader 33 detects the changes in the modulated carrier and recovers the data.

It should be appreciated that while embodiments herein disclose the operation of the RFID module 42 in a passive mode, meaning an initiator/reader device provides an Operating Field and the RFID module responds by modulating the existing field, this is for exemplary purposes and the claimed invention should not be so limited. In other embodiments, the RFID module 42 may operate in an active mode, meaning that the RFID module 42 and the reader device 33 may each generate their own Operating Field. In an active mode, communication is performed by the RFID module and reader device alternately generating an Operating Field. When one of the NFC module and reader device is waiting for data, its Operating Field is deactivated. In an active mode of operation, both the NFC module and the reader device may have its own power supply.

In the exemplary embodiment, the reader device 33 is coupled to the dispenser 26 or the boom end 25C. It should be appreciated that the reader device 33 may be a separate device, such as a portable device that is carried by the operator. In one embodiment, a reader device 33 is provided that communicates wirelessly with the controller 34, such as via a cellular teleconference circuit (including LTE, GSM, EDGE, UMTS, HSPA and 3 GPP cellular network technologies), Bluetooth (IEEE 802.15.1 and its successors) or Wifi (IEEE 802.12) for example. The reader device 33 may be a computing device or a general computing device, such as a cellular (smart) phone or a tablet computer for example. The reader device 33 includes a processor 50 coupled to one or more memory modules 52. The processor 50 may include one or more logical circuits for executing computer instructions. The processor 50 may further include or be coupled to one or more communications circuits 51. The communications circuit 51 couples the processor to the controller 34. The communications circuit 51 may allow for wired or wireless communication between the controller 34 and the reader 33.

Coupled to the processor 50 is an NFC radio 54. The RFID radio 54 includes a transmitter 56 that transmits an RF field (the Operating Field) that induces electric current in the RFID module 42. Where the RFID module 42 operates in a read/write mode, the transmitter 56 may be configured to transmit signals, such as commands or data for example, to the RFID module 42.

The RFID radio 54 may further include a receiver 58. The receiver 58 is configured to receive signals from, or detect load modulation of, the Operating Field by the RFID module 42 and to transmit signals to the processor 50. Further, while the transmitter 56 and receiver 58 are illustrated as separate circuits, this is for exemplary purposes and the claimed invention should not be so limited. In other embodiments, the transmitter 56 and receiver 58 may be integrated into a single module. In one embodiment, the antennas are configured to transmit and receive signals in the 120 kilohertz to 13.56 megahertz frequency.

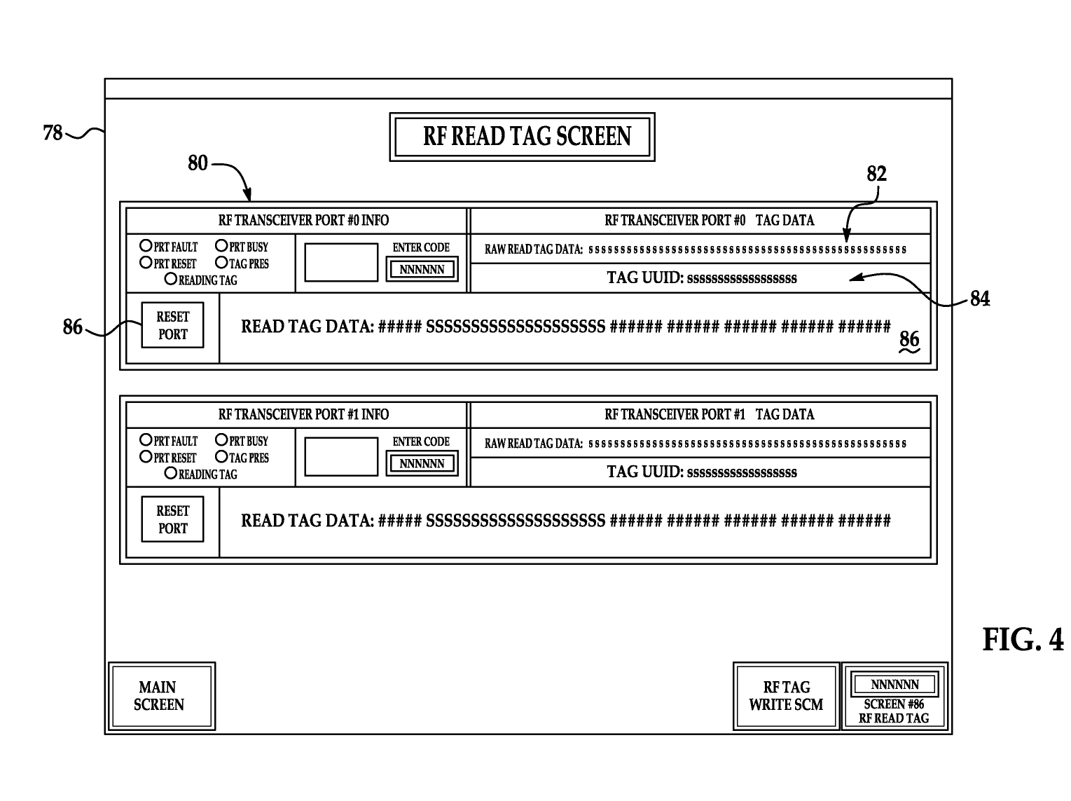

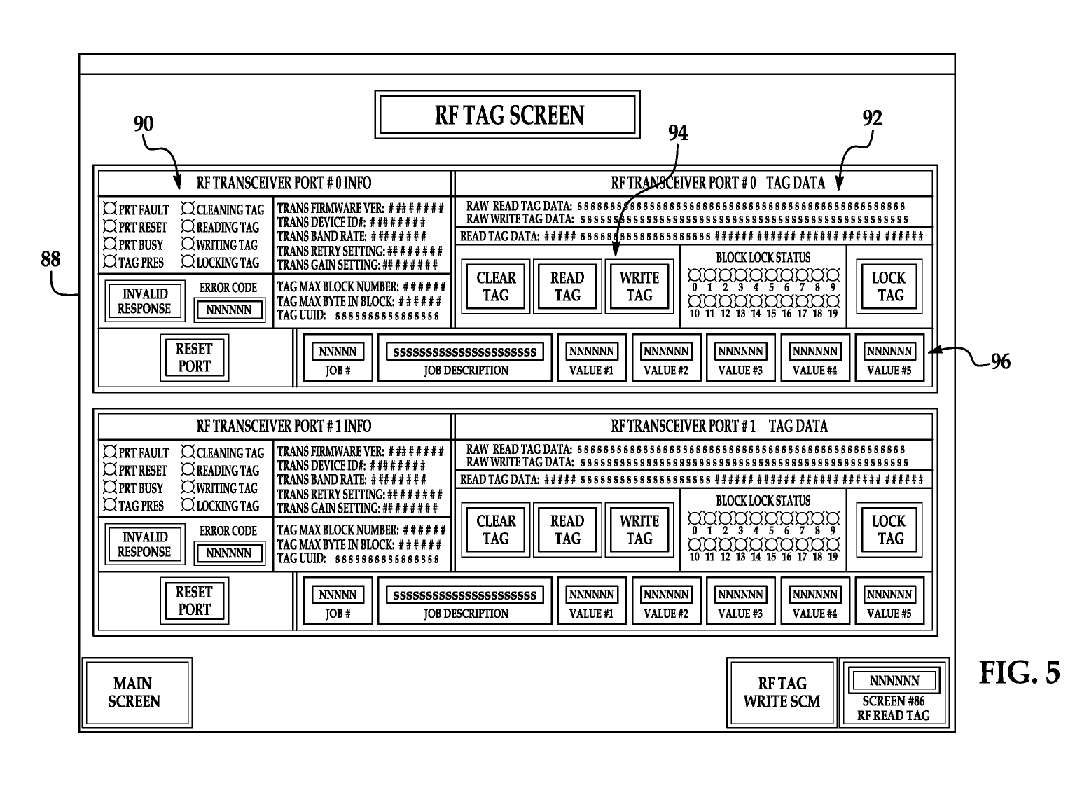

Referring now to FIG. 1 and FIG. 3, an embodiment is shown of the user interface 28 and controller 34. It should be appreciated that while embodiments herein refer to the user interface as being coupled to the dispenser 26, this is for exemplary purposes and the claimed invention should not be so limited. In other embodiments, the user interface may be a portable computing device such as a cellular phone, a smart pad, laptop computer, smart music player, or other type of smart device. In one embodiment, the user interface 28 includes a graphical user interface (GUI) that allows the user to view data, such as material ratios, volume flow rate and dispensing time for example. In one embodiment, the user interface displays a screen such as that shown in FIGS. 4 and 5 for example. In one embodiment, user interface 28 includes a display 60 that is a touch screen device which allows the user to input information and control the operation of the user interface 28 using their fingers.

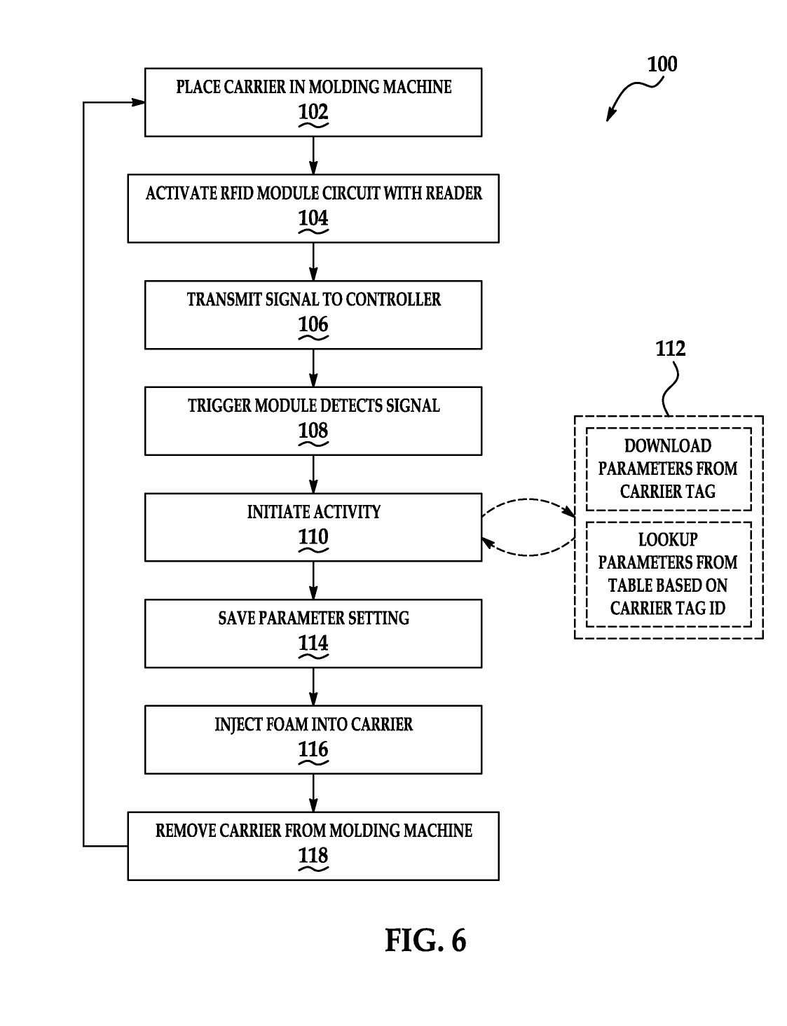

The controller 34 includes a processor 61 that is responsive to executable computer instructions and to perform functions or control methods, such as those illustrated in FIG. 6 for example. Controller 34 may further include memory 62, such as random access memory (RAM) or read-only memory (ROM) for example, for storing application code that is executed on the processor 61 and storing data, such as coordinate data for example. The controller 34 further includes communications circuits, such as a serial communications bus interface 63 (e.g. universal serial bus or USB), local area network (LAN) circuit 64, Bluetooth circuit 66 and WiFi circuit 68 for example. The communications circuits 63, 64, 66, 68 are transceivers, meaning each is capable of transmitting and receiving signals. It should be appreciated that the controller 34 may include additional components and circuits as is known in the art.

Controller 34 may further include additional modules or engines 70, which may be in the form of application software that execute on processor 61 and may be stored in memory 62. In one embodiment, a trigger module 72 is provided that cooperates with the one of the communications circuits to activate one or more modules 70 when the RFID module 42 is brought within range of the RFID reader 33. In one embodiment, the trigger module 72 initiates the downloading of parameters associated with the object to be fabricated in the carrier 36. These parameters may include, but are not limited to, the ratios of constituent materials, the flow rate, and the dispensing time for example.

In another embodiment, the parameter values are stored in a look-up table, such as may be stored in memory 62. In still other embodiments, the parameters are stored in a remote computer server with the RFID module 42 providing a pointer or identification of the carrier 36. The remote computer server may be arranged on the local area network or in a distributed/cloud computer network. It should be appreciated that the remote computer server may be comprised of multiple computers in a distributed computing configuration. Where the parameter values are stored on a remote computer server, advantages may be gained by allowing for updating of the parameters without having to transfer to each individual RFID module 36.

The module 70 may also include a communications module 74 that establishes communications with the RFID reader 33 or RFID module 42 for example. The modules 70 may also include a parameters module 76, which allow the operator to display or change settings and parameter values.

Once the RFID module 42 and the controller 34 establish communication via the RFID reader 33, the configuration of the foam molding machine 20 may be automatically performed to allow the fabrication of objects with the carrier 36

FIG. 4 illustrates an exemplary GUI 78 displayed on the display 60 to the operator 32 when the RFID module 42 is read by the reader 33. The information displayed on the GUI 78 includes RFID reader 33 status indicators 80, RFID module data 82, RFID module ID 84 and module data 86. A reset button 86 may be provided to reset the RFID reader 33.

FIG. 5 illustrates an exemplary GUI 88 that is used to program the RFID module 42. In the exemplary embodiment, the GUI 88 is secured using a password to allow authorized operators to make changes to the data stored on the RFID module 42. The GUI 88 includes information 90 on the RFID reader 33, including the status, reader ID and parameters. The GUI 88 further include information 92 on the RFID module 42 and may include virtual buttons 94 that allow the user to clear the RFID module, read the RFID module and write-to the RFID module. The GUI 88 also allows the user to input a plurality of values 96 that define the parameters for fabricating the object in the carrier 36 associated with the RFID module. Finally, the GUI 88 includes a virtual button 98 that allows the user to lock the RFID module 42 and prevent operators from changing the values.

Referring now to FIG. 6, a process 100 is shown for fabricating objects in a foam molding machine. The process 100 starts by placing the carrier 36 in the foam molding machine 20 in box 102. When the RFID module 42 is brought within range of the reader 33 (e.g. by lowering the boon end 25C towards the carrier 36), the RFID module 42 is activated as discussed above. The reader 33 then transmits in box 106 a signal to the controller 34. This signal is detected by the trigger module 72 and the controller 34 initiates activity 112 in box 110. The activity 112 may include the transmission of a signal from the RFID module 42 to the controller, where the signal include the molding parameter values for the object being formed by carrier 36 or and identification value (e.g. RFID tag UUID) that allows the parameter values to be determined in either a look-up table or on a remote server based. The process 100 then proceeds to save the parameters in box 114. The foam molding machine 20 then formulates the desired foam material from the constituent materials and injects the foam material into the carrier 36 in box 116. The first and second portions 38, 40 of the carrier 36 are closed and the foam material is allowed to expand and start to set (cure). The steps of box 116 may be repeated until the desired number of objects is formed. The carrier 36 may then be removed from the foam molding machine 20 in box 118. If additional different objects need to be formed, the process 100 loops back to box 102 and a new carrier 36 is placed into the foam molding machine 20.

A technical effect of embodiments of the invention includes the automatic configuration of a form molding machine for a particular carrier with reduced or no intervention by the operator.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A foam molding machine comprising:
a molding assembly configured to mix a plurality of constituent materials to form a molding material;
a dispenser operably coupled to receive the molding material;
a carrier positioned to receive the molding material from the dispenser, the carrier being removably coupled to the foam molding machine;
an RFID module coupled to the carrier;
an RFID reader arranged to receive a signal from the RFID module when the carrier is arranged in the foam molding machine; and
a controller operably coupled to the RFID reader and the molding assembly, wherein the controller includes a processor that is responsive to executable computer instructions for changing molding parameters in response to the RFID reader receiving the signal from the RFID module.

2. The foam molding machine of claim 1 wherein the parameters include at least one of a ratio of the constituent materials, a dispensing time and a molding material flow rate.

3. The foam molding machine of claim 2 wherein the signal includes parameter values that define the parameters.

4. The foam molding machine of claim 2 wherein the signal includes an identification value.

5. The foam molding machine of claim 4 wherein the processor is further responsive to executable instructions for retrieving parameter values that define the parameters from a look-up table based at least in part on the identification value in response to receiving the signal.

6. The foam molding machine of claim 4 wherein the processor is further responsive to executable instructions for retrieving parameter values that define the parameters from a remote server based at least in part on the identification value in response to receiving the signal.

7. A method of forming an object comprising:
placing a carrier in a foam molding machine, the carrier including an RFID module, the carrier further having a first portion movably coupled to a second portion;
activating the RFID module with an operating field transmitted by an RFID reader operably coupled to the foam molding machine;
transmitting a signal from the RFID module to the RFID reader;
changing molding parameters in the foam molding machine in response to receiving the signal;
dispensing a foam material into the carrier;
closing the first portion and second portion to define the object;
expanding the foam material within the carrier; and
removing the object from the carrier.

8. The method of claim 7 wherein the signal includes parameter values and the molding parameters are changed based at least in part on the parameter values.

9. The method of claim 8 wherein the parameter values include at least one of a ratio of the constituent materials, a dispensing time and a molding material flow rate.

10. The method of claim 7 wherein the signal includes an identification value.

11. The method of claim 10 further comprising:
retrieving parameter values from a look-up table based at least in part on the identification value; and
wherein the step of changing the molding parameters is based at least in part on the parameter values.

12. The method of claim 10 further comprising:
retrieving parameter values from a remote server based at least in part on the identification value; and
wherein the step of changing the molding parameters is based at least in part on the parameter values.

13. The method of claim 7 wherein:
the step of activating the RFID module includes lowering an end of a boom of the foam molding machine; and
the RFID reader is operably coupled to the end of the boom.

14. A foam molding machine comprising:
a molding assembly configured to mix a plurality of constituent materials to form a molding material;
a boom coupled to the molding assembly and movable between at least a first position and a second position;
a dispenser coupled to an end of the boom opposite the molding assembly, the dispenser configured to receive the molding material;
a carrier positioned to receive the molding material from the dispenser, the carrier being removably coupled to the foam molding machine;
an RFID module coupled to the carrier;
an RFID reader arranged to receive a signal from the RFID module when the carrier is arranged in the foam molding machine; and
a controller operably coupled to the RFID reader and the molding assembly, wherein the controller includes a processor that is responsive to executable computer instructions for changing molding parameters in response to the RFID reader receiving the signal from the RFID module.

15. The foam molding machine of claim 14 wherein the parameters include at least one of a ratio of the constituent materials, a dispensing time and a molding material flow rate.

16. The foam molding machine of claim 15 wherein the signal includes parameter values that define the parameters.

17. The foam molding machine of claim 15 wherein the signal includes an identification value.

18. The foam molding machine of claim 17 wherein the processor is further responsive to executable instructions for retrieving parameter values that define the parameters from a look-up table based at least in part on the identification value in response to receiving the signal.

19. The foam molding machine of claim 17 wherein the processor is further responsive to executable instructions for retrieving parameter values that define the parameters from a remote server based at least in part on the identification value in response to receiving the signal.
